(19) United States
(12) Patent Application Publication
(10) Pub. No.: US 2014/0362776 A1
(43) Pub. Date: Dec. 11, 2014

(54) APPLICATION AWARE ASSOCIATION IN WIRELESS NETWORKS

(71) Applicant: QUALCOMM Incorporated, San Diego, CA (US)

(72) Inventors: Qingjiang Tian, San Diego, CA (US); Peerapol Tinnakornsrisuphap, San Diego, CA (US); Sai Yiu Duncan Ho, San Diego, CA (US); Bibhu Mohanty, San Diego, CA (US); Arnaud Meylan, San Diego, CA (US)

(21) Appl. No.: 13/912,882

(22) Filed: Jun. 7, 2013

(51) Int. Cl. H04W 48/20

(52) U.S. Cl. CPC H04W 48/20
USPC 370/329

(57) ABSTRACT

An application may be associated with an application endpoint that is accessed via a wireless local area network. In this disclosure, a wireless station may select and associated with one of a plurality of access points that provides better application throughput to the application endpoint. The application throughput may be based upon a combination of the wireless link rate (between the wireless station and the access point) as well as a measured application data rate (from the access point to the application endpoint). An access point may measure and advertise application data rates for a plurality of application endpoints, including one or more servers coupled to the local area network, a gateway to a wide area network, and/or a server coupled to the wide area network.

### BACKGROUND

Embodiments of the inventive subject matter generally relate to the field of wireless communications and, more particularly, to various techniques for associating with a wireless local area network.

In wireless communication systems, one or more access points may be employed to connect any number of wireless stations to a wireless local area network (WLAN). The WLAN may provide connectivity to a wide area network (WAN), such as the Internet or the like. Furthermore, WLAN may provide connectivity to one or more servers located in the WLAN. The WLAN may be implemented with multiple wireless access points (APs) dispersed throughout a geographic region. Each of these access points provides a wireless coverage area which may or may not partially overlap with a coverage area of a nearby access point. One or more of the access points may be equipped with a wired backhaul connection to the WAN.

When a wireless station is introduced to the WLAN, the wireless station may associate with an access point to gain access via the WLAN to one or more local servers located in a local area network or to a wide area network. A wireless station associates with an access point by establishing a wireless connection with the access point. A wireless station may generally attempt to associate with an access point that will provide it with the strongest received signal strength (RSSI). It is typically assumed that the highest RSSI will provide the best wireless throughput between the wireless station and the access point.

### SUMMARY

Various embodiments are disclosed in which communication metrics regarding application data rates from an access point to various application endpoints may be communicated to a wireless station. The wireless station may utilize the communication metrics to determine with which access point the wireless station should associate based upon application requirements at the wireless station.

In one embodiment, a wireless station executes an application associated with a target application endpoint accessible via a wireless network. The wireless station may determine a first estimated throughput from the wireless station to the target application endpoint via a first access point of the wireless network, wherein said first estimated throughput is based, at least in part, upon a first wireless link rate associated with the first access point and a first application data rate from the first access point to the target application endpoint. The wireless station may also determine a second estimated throughput from the wireless station to the target application endpoint via a second access point of the wireless network, wherein said second estimated throughput is based, at least in part, upon a second wireless link rate associated with the second access point and a second application data rate from the second access point to the target application endpoint. The wireless station may select and associate with one of the first access point or the second access point based, at least in part, upon the first estimated throughput and the second estimated throughput.

In another embodiment, an access point determines communications metrics including application data rates from the access point to various application endpoints. The access point communicates the communications metrics to at least one wireless station.

### BRIEF DESCRIPTION OF THE DRAWINGS

The present embodiments may be better understood, and numerous objects, features, and advantages made apparent to those skilled in the art by referencing the accompanying drawings.

FIG. 1 depicts an example system diagram in which a wireless station associates with a wireless access point based upon application endpoint in accordance with an embodiment of this disclosure.

FIG. 2 depicts an example system diagram in which a wireless station determines estimated application throughput in accordance with an embodiment of this disclosure.

FIG. 3 depicts an example system diagram in which a hybrid device includes a wireless access point in accordance with an embodiment of this disclosure.

FIG. 4 depicts an example message format in accordance with an embodiment of this disclosure.

FIG. 5 depicts an example message flow diagram in accordance with an embodiment of this disclosure.

FIG. 6 depicts an example flow chart for performance by a wireless station in accordance with an embodiment of this disclosure.

FIG. 7 depicts an example flow chart for performance by an access point in accordance with an embodiment of this disclosure.

FIG. 8 depicts an example electronic device suitable for various embodiments of this disclosure.

### DESCRIPTION OF EMBODIMENT(S)

The description that follows includes exemplary systems, methods, techniques, instruction sequences and computer program products that embody techniques of the present inventive subject matter. However, it is understood that the described embodiments may be practiced without these specific details. For instance, although examples may refer to particular applications or application endpoints, the scope of this disclosure is not limited by the examples. In other instances, well-known instruction instances, protocols, structures and techniques have not been shown in detail in order not to obfuscate the description.

In a wireless network, wireless station may associate with an access point during startup, during handover, or upon determining a need to transmit data associated with an application. A wireless station typically associates with the access point (AP) that provides the strongest received signal strength (RSSI). For example, in a conventional WLAN, a wireless station may determine a first RSSI based upon beacon packets received from a first AP and a second RSSI based upon beacon packets received from a second AP. Traditionally, the wireless station may cause a wireless association with the AP that is associated with the strongest of the first RSSI and the second RSSI. However, the AP with strongest RSSI may not provide the highest application throughput to a particular application endpoint. For example, an AP with a stronger RSSI may have a saturated upstream connection or less backhaul capacity than another AP with a weaker RSSI. The traditional approach may not consider the backhaul link rate available at each AP, the backhaul link channel utilization or capacity, or the application data rate that each AP can provide to various application endpoints.

In accordance with various embodiments of this disclosure, a plurality of applications may be associated with corresponding application endpoints. As non-limiting examples, an application endpoint may be a local server coupled to a local area network or a server coupled to a wide area network. Various non-limiting examples of applications may include a media player, a web browser, a user downloadable application, a voice over Internet Protocol (VoIP) client, a synchronization client, or other various applications. Each application may be associated with one or more application endpoints. For example, a media player may be associated with a streaming media server. Another common application endpoint may include a gateway or router device which provides connectivity to a public wide area network (such as the Internet). Application throughput refers to a data throughput (or goodput) between an application on a wireless station and the application endpoint. The application throughput may be limited by one or more portions of a data transmission path from the wireless station to the application endpoint.

In accordance with an embodiment of this disclosure, a wireless station may determine which AP would provide the highest application throughput from the wireless station to an application endpoint. The application throughput may be based upon the wireless link between wireless station and the access point, as well as the application data rate from the AP to the application endpoint. In one embodiment, each AP may broadcast a measured application data rate that the AP can provide to an application endpoint, such as a server in the local area network or a gateway device providing access to a wide area network. The wireless station may associate with the AP which can provide the highest estimated application throughput rather than simply by RSSI alone.

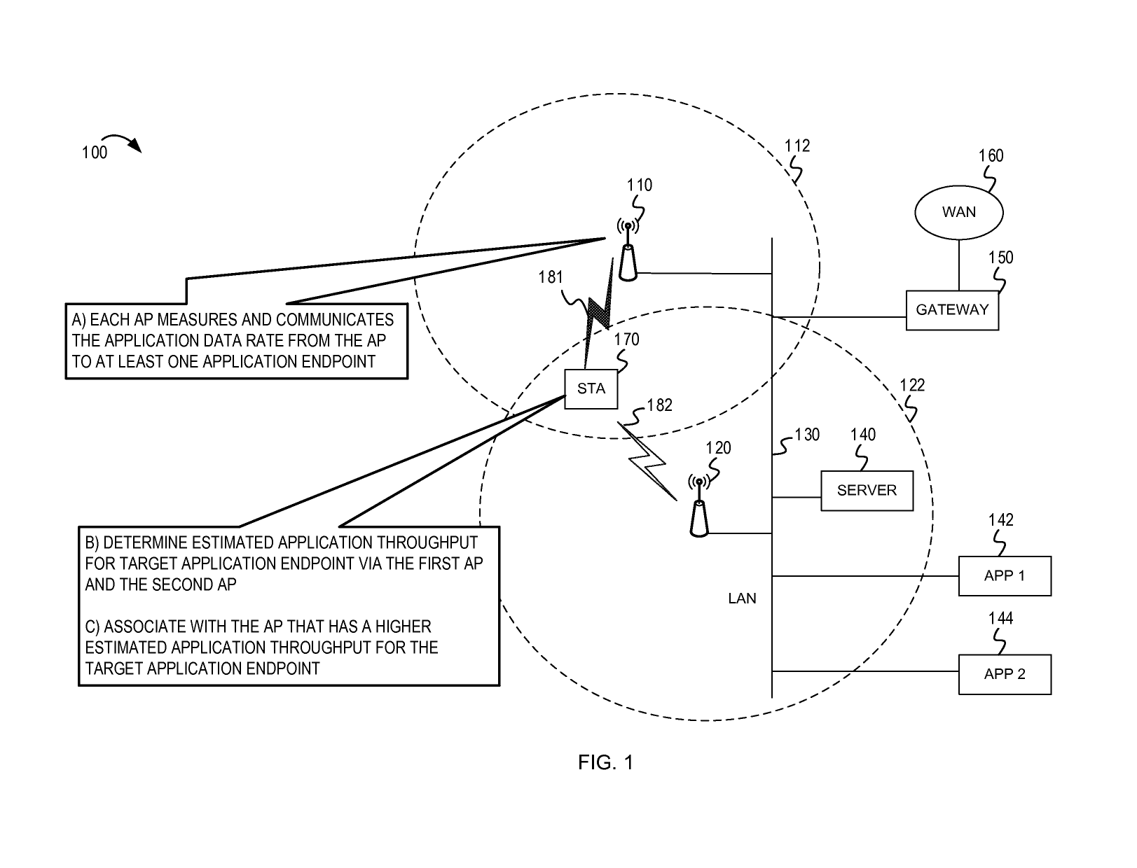

FIG. 1 depicts an example system 100 that includes a first AP 110 and a second AP 120. Together, the first AP 110 and second AP 120 may comprise part of a wireless local area network (WLAN). The first AP 110 is associated with a first coverage area 112. The second AP 120 is associated with a second coverage area 122. Each of the first AP 110 and second AP 120 are communicatively coupled to a local area network (LAN) 130. For example, the LAN 130 may include a wireline network, such as Ethernet, powerline communications (PLC), coaxial network, or other LAN technologies. It should be understood that local area networks described in this disclosure include both wired and wireless local area networks.

A server 140 is also communicatively coupled to the LAN 130. A gateway 150 is communicatively coupled to the LAN 130 and provides access to a wide area network (WAN) 160. It should be understood that the gateway 150 may also be referred to as a router, bridge, proxy device, or other terms to refer to a networking device that provides access to a WAN. The gateway 150 may also be collocated with one of the access points or with another device. In some embodiments, the gateway 150 may also include a modem, such as a DSL modem, PLC modem, or the like. In some embodiments, the system 100 may include a plurality of application endpoints, including the server 140, the gateway 150, or other example application servers 142, 144.

In FIG. 1, a wireless station 170 may be introduced to the WLAN. Other terms for wireless station may include user equipment (UE), mobile device, wireless device, user device, or the like. The wireless station 170 may be, by way of example, a mobile or cellular phone, a personal digital assistant (PDA), a laptop computer, a digital audio device (e.g., an MP3 player), a game console, a digital camera, or other voice, data, audio, video, messaging, or multimedia device. Typically, a wireless station 170 may scan a set of frequencies to detect the presence of one or more access points. The access points, such as first AP 110 and second AP 120, may periodically broadcast discovery information. For example, the access points may transmit a periodic beacon packet which includes basic information about the access point, such as an identifier (e.g., subscriber set identifier, SSID, or the like) or wireless link rate information. Each access point may be capable of using one or more wireless link rates for wireless communications with wireless stations.

A wireless link rate may be associated with a defined wireless protocol. There are currently several different wireless protocols which enable wireless communications between devices. Each protocol may provide different features that impact range of coverage, speed, reliability, etc. As non-limiting examples, IEEE defines several protocols traditionally used for consumer devices. For example, the IEEE 802.11n wireless network protocol provides a good range, and has a throughput of about 54 Mbit/s to 150 Mbit/s. The IEEE 802.11ac wireless network protocol enables multi-station wireless area networks to have throughput of about 1 Gbit/s, and provides a maximum single link throughput of about 500 Mbit/s. The IEEE 802.11ad wireless network protocol (sometimes also referred to as “11ad” or WiGig™), has a maximum throughput of about 7 Gbit/s, and may have a limited range. Other wireless network protocols are existent and may have different characteristics. Other examples of wireless network protocols may be used or later developed.

In addition to detecting the wireless link rate capable for each access point, the wireless station 170 may also measure the received signal strength of the beacon packet transmissions. A received signal strength indicator (RSSI) is a value commonly used by persons of skill in the art to refer to the strength of the wireless signal. Other indicators, such as signal to noise ratio (SNR) or channel quality indicator (CQI) may be used to determine the quality of the wireless link between the wireless station 170 and one of the access points 110, 120.

However, while a particular access point may transmit signals with a stronger RSSI measured by the wireless station, the access point may not be associated with higher application throughput to a particular application endpoint. The application throughput provided via an access point may also be limited by the application data rate from the AP to the application endpoint. In FIG. 1, the wireless station 170 may have application traffic destined to the server 140. In one example, the wireless station 170 may be physically closer to the first AP 110 and may measure a higher RSSI for the first AP 110 than for the second AP 120. However, the first AP 110 may have a lower application data rate for the communications link between the first AP 110 and the server 140. For example, the wireline interface of the first AP 110 may be saturated or congested. Higher packet loss rates or channel utilization may result in poorer application data throughput associated with the communications link between the first AP 110 and the server 140. However, the second AP 120 may have a lower RSSI measured by the wireless station 170 but have a higher application data rate for the communications link between the second AP 120 and the server 140. Therefore, it may be desirable for the wireless station 170 to associate with the second AP 120 based on estimated application throughput rather than the first AP 110 based on RSSI.

It should be understood that the RSSI may also be used to select an access point, in addition to the estimated application throughput. For example, the measured RSSI may be used with a minimum threshold value to determine eligible access points prior to determining estimated application throughput associated with the eligible access points. In WLANs, associating with an access point may include a wireless connection establishment process for the wireless station, and may include authentication or other messages exchanged with the access point. Typically the wireless station will remain associated with an access point until the expiration of a timer, loss of signal, a change in signal strength, based upon an instruction from the access point, or other triggers that terminate an association session. In accordance with several wireless network protocols, the wireless station typically associates with only one access point at any given time.

In this disclosure, the wireless station may select which access point to associate with based upon application requirements of the wireless station and estimated application throughput that is determined for each of the access points. The estimated application throughput takes into consideration the upstream application data rate or other communications metrics regarding the communications link from the access point to the application endpoint. Shown at block A, the access point may measure an application data rate between the access point and at least one application endpoint. The application data rate may be communicated in the beacon packet or other message from the access point to the wireless station. The access point may advertise or broadcast application data rate or communications metrics for one or more application endpoints. For example, the access point may measure and advertise an application data rate for a communications connection between the access point and the server 140. The access point may also measure and advertise another application data rate for a communications connection from the access point to an application server in the WAN 160 or to the gateway device 150 that provides access to the WAN 160.

Shown at block B, the wireless station may determine an estimated application throughput to a target application endpoint via each of the first AP 110 and the second AP 120. The estimated application throughput for each AP may be based upon the wireless link rate (or other metrics regarding the wireless link) for each AP and the application data rate (or other communications metrics) associated with the backhaul communications link from each AP to the application endpoint. Shown at block C, the wireless station may associate with the AP that has a higher estimated application throughput to the target application endpoint.

The application or applications that are executing on the wireless station 170 may impact the selection of one of multiple available access points. Depending on the particular target application endpoint, the estimated application throughput via each AP may be different. For example, in one embodiment, when the wireless station 170 is executing a first application associated with a first application server 142, the estimated application throughput may be higher for the first AP 110. And when the wireless station 170 is executing a second application associated with a second application server 144, the estimated application throughput may be higher for the second AP 120. Therefore, selection of the access point may be dependent, at least in part, upon which target application endpoint(s) are required for application(s) that are executing at the wireless station. When multiple applications are executing at the wireless station, a weighting maybe used based on the packet rate, packet size, data type, or other metrics. In this disclosure, the wireless station may be capable of determining application requirements and make an application-aware association with one of a plurality of access points that provide sufficient application throughput associated with the application requirements.

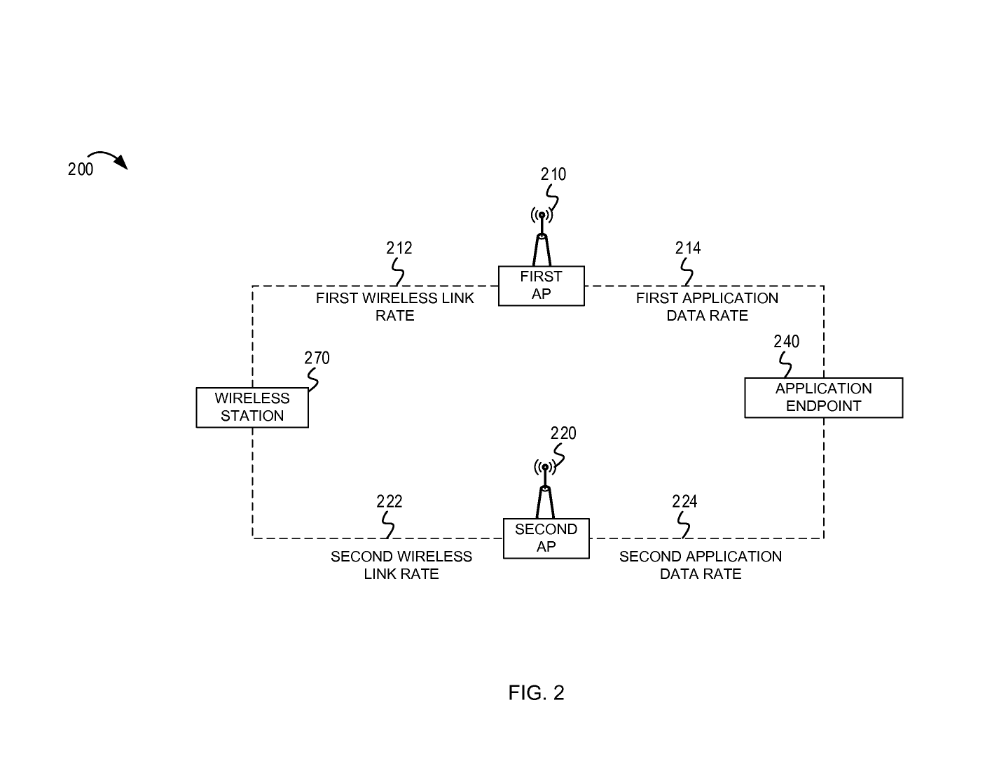

FIG. 2 shows an example system 200 in which the wireless station 270 may determine estimated application throughput from the wireless station 270 to an application endpoint 240 via a first AP 210 and a second AP 220. The first wireless link rate 212 from the first AP 210 may be defined as “R1.” The first application data rate 214 from the first AP 210 to the application endpoint 240 may be defined as “R2.” If the connection from the first AP 210 to the application endpoint 240 is not a wireless connection, then communications from the wireless station to the application endpoint 240 can be determined to be the lower of R1 and R2. If the communications link from the first AP 210 to the application endpoint 240 uses the same wireless channel as the wireless link from the wireless station to the first AP 210, then the two rates “contend” for packet transmission over the same wireless channel and the estimated application throughput may be determined as a calculation of α*(R1*R2)/(R1+R2), wherein α represents a configurable coefficient variable or function.

Using information about the first application data rate 214, the wireless station 270 determines a first estimated application throughput to the application endpoint 240 for the communications path via the first AP 210. Similarly, the wireless station 270 may use information about the second application data rate 224 to determine a second estimated application throughput to the application endpoint 240 for the communications path via the second AP 220

If the wireless station is executing an application for which packets are exchanged to the application endpoint, the wireless station should associate with the AP which can provide the highest estimated application throughput. It should be understood that while FIG. 2 depicts a single application endpoint 240, in various embodiments, the access points will provide connectivity to a plurality of application endpoints. The access points may be suitable for detecting application endpoints based upon previous traffic, port scanning, configuration, or other methods of identifying application endpoints. In some embodiments, the access points may measure application data rates from the access point to the plurality of application endpoints. The measured application data rates may be included in a message communicated to the wireless station.

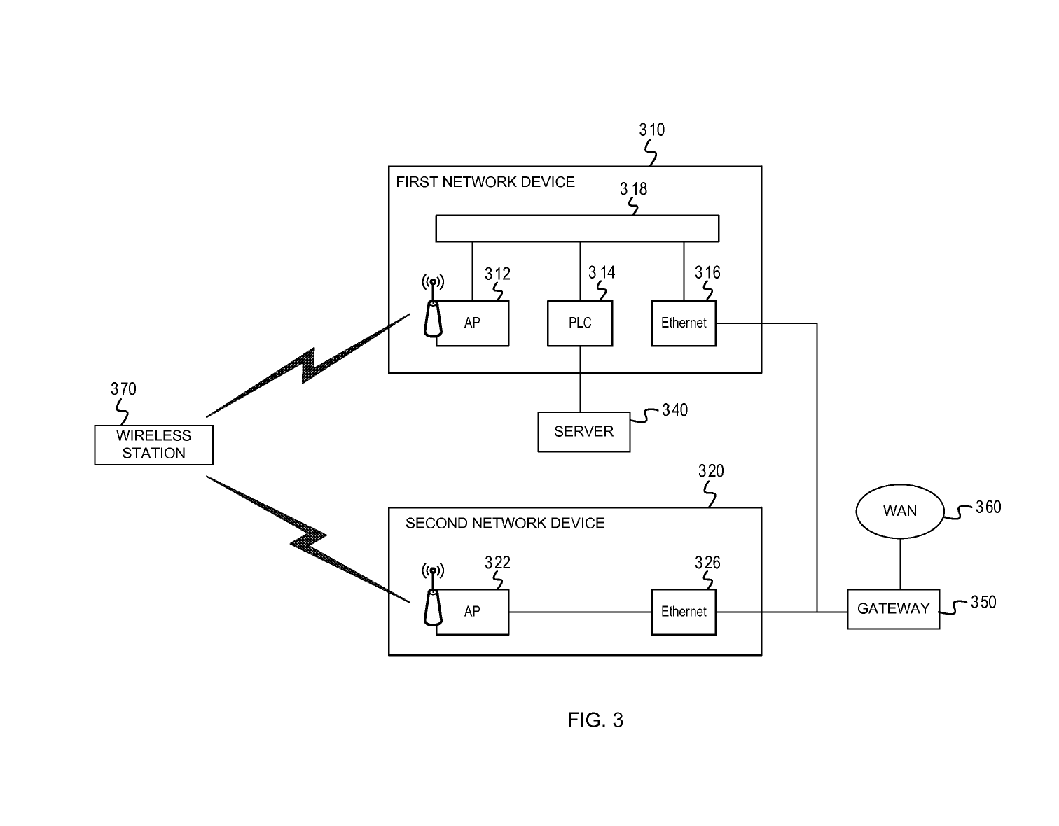

In FIG. 3, a wireless station 370 may be in a WLAN that has a first network device 310 and a second network device 320. In this example, the first network device 310 includes a first AP 312, a PLC interface 314 and an Ethernet interface 316. The first network device 310 may be referred to as a hybrid device. For example, the first network device 310 may implement IEEE P1905.1-compliant protocols.

In the example of FIG. 3, the first network device 310 has a PLC communications link to a server 340 as well as an Ethernet communications link to a gateway 350 that provides access to a WAN 360. The second network device 320 includes a second AP 322 and an Ethernet interface 326 with an Ethernet communications link to the gateway 350.

In one embodiment, the server 340 may represent a first application endpoint in the local area network. The gateway 350 may represent a second application endpoint in the local area network or may be used to represent an application endpoint for WAN applications. In some implementations, a WAN server (not shown) in the WAN 360 may be used as a further application endpoint.

In an example described with regard to FIG. 3, the first network device 310 may measure a first local application data rate from the first network device to the server 340. The first network device may also measure a first external application data rate from the first network device to the gateway 350 (or, alternatively, to a WAN resource in the WAN 360). The first network device 310 may communicate the first local application data rate and the first external application data rate to the wireless station 370. For example, information about the first local application data rate and the first external application data rate may be included in an extended Beacon packet. Alternatively, information about the first local application data rate and the first external application data rate may be sent in a unicast message to the wireless station or to a centralized resource that aggregates the application data rate measurements from multiple access points.

Similar to the first network device 310, the second network device 320 may measure and communicate a second local application data rate associated with communications from the second network device 320 to the server 340. It is noted that the communications from the second network device 320 to the server 340 may include a communications path that includes the first network device 310. The second network device 320 may measure and communicate a second external application data rate associated with a communications path from the second network device 320 to the gateway 350 (or, alternatively, to the WAN resource in the WAN 360).

The wireless station 370 may collect the application data rate information from both the first network device 310 and the second network device 320. The wireless station 370 may determine an estimated local application throughput for each of the access points and an estimated external application throughput for each of the access points. If the wireless station 370 is executing an application that primarily communicates with servers on the local area network, then the wireless station 370 may select the access point that provides the highest estimated local application throughput. If the wireless station 370 is executing an application that primarily communicates with the WAN 360, then the wireless station 370 may select the access point that provides the highest external application throughput.

It should be understood that the wireless station may be executing multiple applications, some of which may be associated with the local area network and some of which may be associated with the WAN 360. The wireless station may determine a combined estimated application throughput based upon the mix of application traffic. For example, the wireless station 370 may include a proportional amount of the estimated local application throughput and a proportional amount of the estimated external application throughput, the proportions determined based upon application requirements of the multiple applications at the wireless station. In one implementation, weighting factors may be determined based on the application requirements (e.g., packet size and/or frequency) for the mix of applications running at the wireless station. The weighting factors may be used when combining the estimated local application throughput and estimated external application throughput.

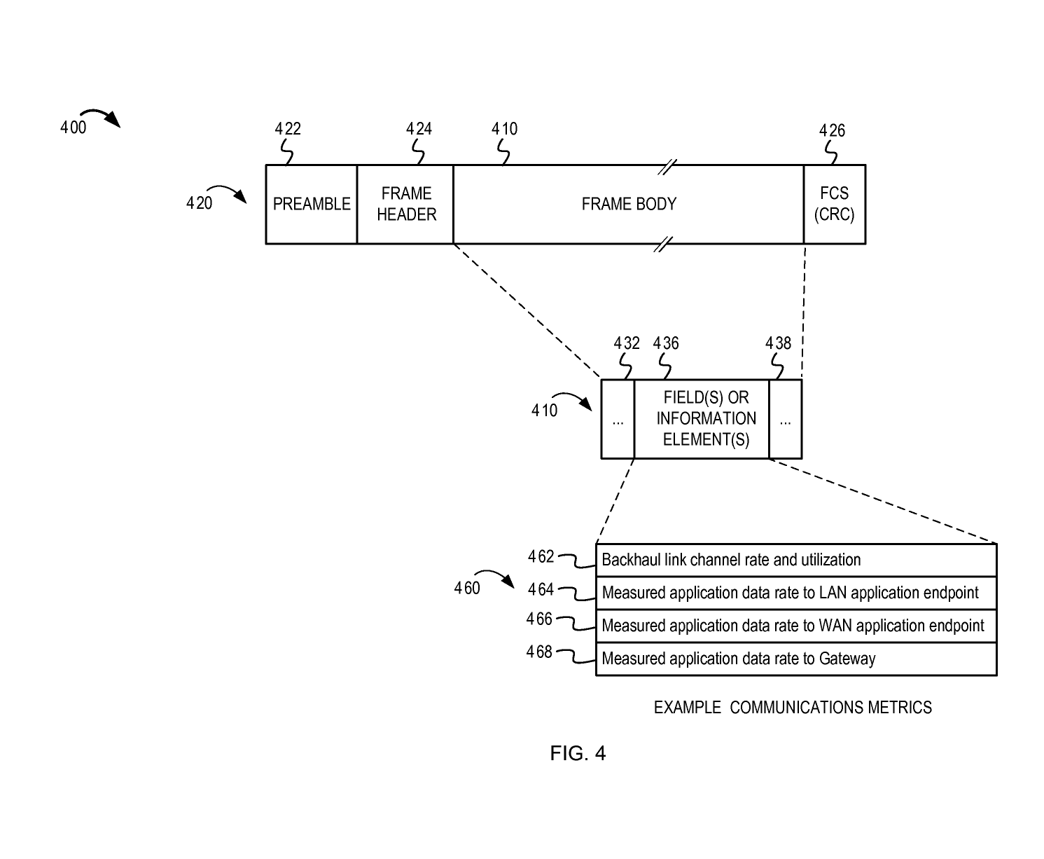

FIG. 4 depicts an example message format 400 used by an access point to communicate application data rates in accordance with one embodiment of this disclosure. It should be understood that the example message format is a non-limiting example, and that any variety of broadcast or unicast messages may be employed to communicate one or more application data rates. Furthermore, fields may be added or omitted to the example message format 400 without departing from the scope of this disclosure.

The example message format 400 includes a protocol data unit (PDU) 420 (sometimes also referred to as a frame or packet in various implementations). The PDU 420 includes a preamble 422, a frame header 424, a frame body 410, and a frame check sequence (FCS) 426 (such as a cyclic redundancy check, CRC). In one example, the frame header 424 may include a source address and destination address associated with the message. In another example, the frame header 424 may omit the destination address or use a generic destination address, such as a broadcast address. The frame header 424 may include information that identifies the contents of the frame body 410.

The frame body 410 may be organized with a message format and may include a variety of fields or information elements 432, 436, 438. In one example, the frame body 410 includes a protocol identifier (not shown) that indicates the message includes application data rates for one or more application endpoints. Various fields or information elements may include communications metrics, such as the application data rates for various application endpoints. Several example communications metrics 460 are illustrated as non-limiting examples in FIG. 4. For example, the communications metrics may include a backhaul link channel rate and/or utilization 462, a measured application data rate to a LAN application endpoint 464, a measured application data rate to a WAN application endpoint 466, and/or the measured application data rate to a gateway device 468. In some implementations, a separate information element 432, 436, 438 may be included for each application endpoint described in the message. The information element may include an identifier of the particular application endpoint and the measured application data rate (from the access point to the particular application endpoint) for the particular application endpoint.

In one embodiment, the application data rates are included in a broadcast message (such as a beacon packet) from the access point. An existing message format may be extended to include vendor-specific information elements for containing the application data rates for various application endpoints.

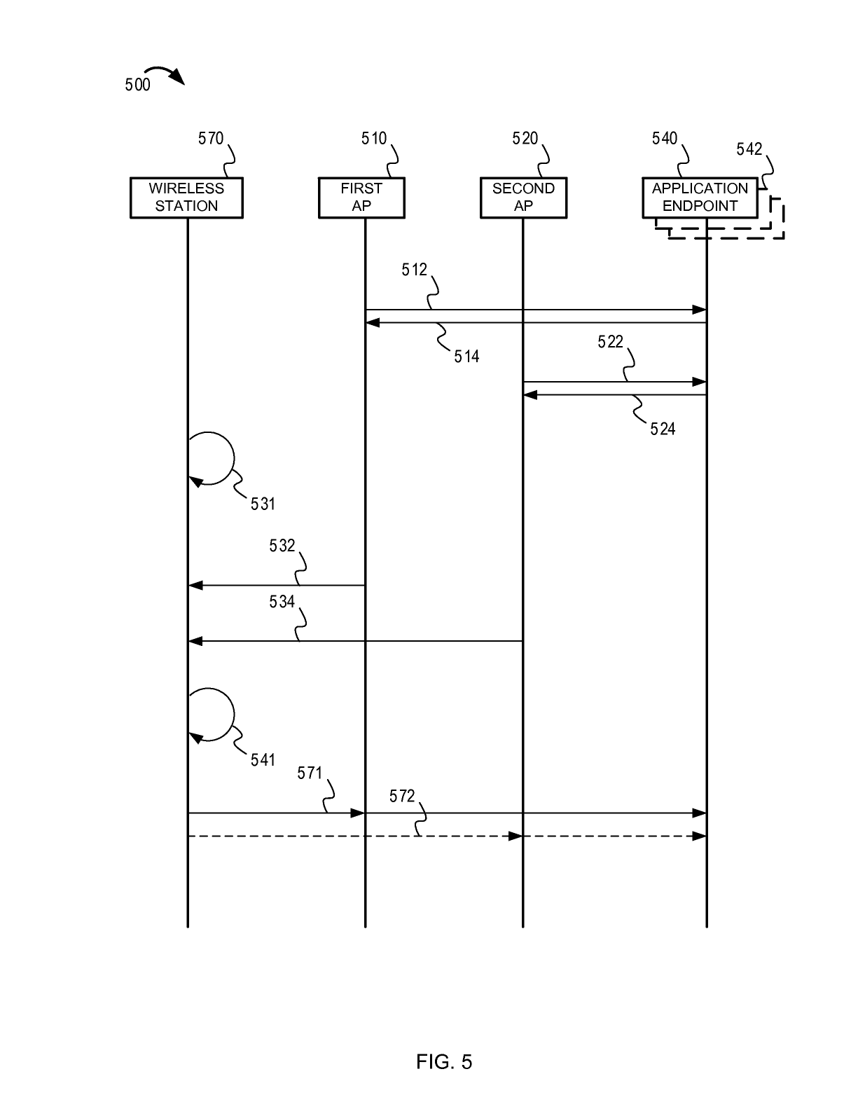

FIG. 5 depicts an example message flow diagram 500 in accordance with an embodiment of this disclosure. The message flow diagram 500 shows a wireless station 570, first AP 510, second AP 520 and a plurality of application endpoints 540, 542. For the purposes of brevity, the message flow describes operations in terms of application endpoint 540, but it should be understood that various operations may be performed for each application endpoint.

The message flow diagram 500 shows that each of the first AP 510 and second AP 520 measure respective application data rates to the application endpoint 540. For example, the first AP 510 may generate one or more messages 512 to the application endpoint 540 and measure delay or throughput associated with responses 514 from the application endpoint 540. Similarly, the second AP 520 may generate one or more messages 522 to the application endpoint 540 and measure delay or throughput associated with responses 524 from the application endpoint 540. The first AP 510 and second AP 520, therefore, become aware of the application data rate associated with the communications path between the APs 510, 520 and the application endpoint 540. There may be other ways in which the APs 510, 520 become aware of the application data rate associated with the communications path to the application endpoint 540. In some implementations, each AP may estimate the application data rate based upon link capacity, link rate, channel utilization, or other metrics associated with one or more communications segments in the path between the AP and the application endpoint 540.

At 531, the wireless station 570 may scan a frequency band to detect available access points. For example, the wireless station 570 may perform a discovery protocol to discover the presence of first AP 510 and second AP 520. Each AP communicates the application data rate associated with at least one application endpoint. For example, each AP may be configured to periodically broadcast a beacon packet in accordance with a WLAN protocol. The AP may include information about the application data rate in the beacon packet. In FIG. 5, the first AP 510 may transmit a broadcast message 532 which is detected by the wireless station 570. The broadcast message 532 may include the application data rate associated with the communications path from the first AP 510 to the application endpoint 540. Similarly, the second AP 520 may transmit a broadcast message 534 which is detected by the wireless station 570. The broadcast message 534 may include the application data rate associated with the communications path from the second AP 520 to the application endpoint 540.

At 541, the wireless station 570 may determine the estimated application throughput to the application endpoint 540 for each potential wireless connection via the first AP 510 and the second AP 520. The wireless station may select the access point which has the highest estimated application throughput. In FIG. 5, the wireless station 570 may associate with the first AP 510 to send traffic 571 to the application endpoint 540. However, if the estimated application throughput for the second AP 520 were higher, the wireless station 570 may associated with and send traffic 572 via the second AP 520.

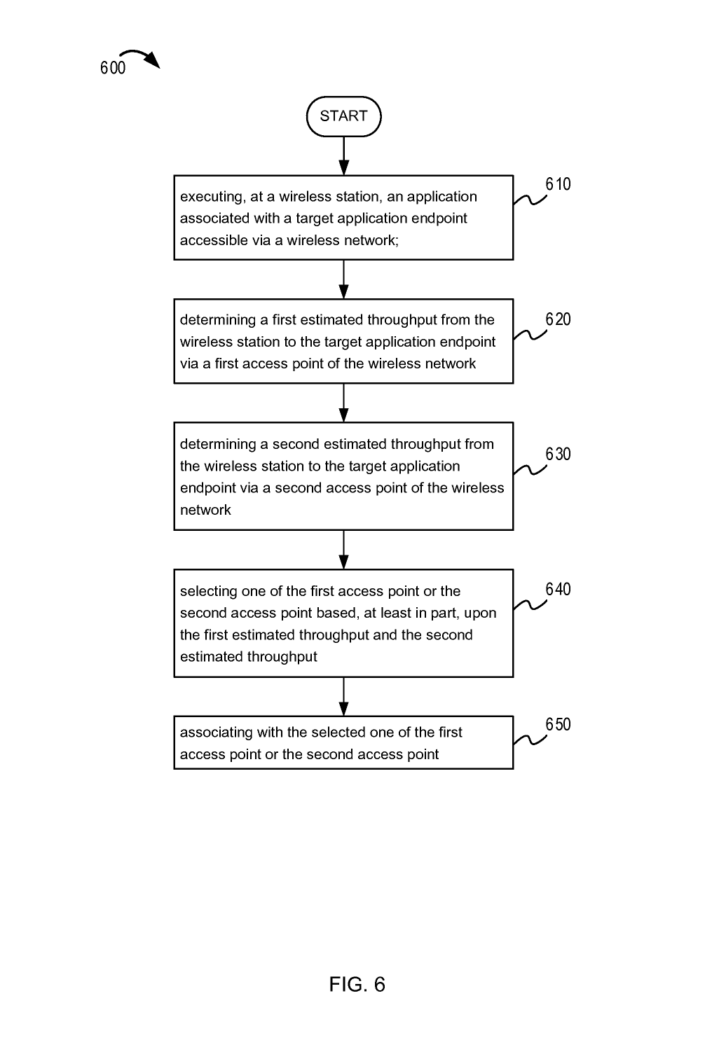

FIG. 6 depicts an example flow chart 600 for method performed by a wireless station in accordance with an embodiment of this disclosure. The operations described in FIG. 6 are non-limiting examples, and various operations may be optionally omitted or added in particular implementations.

At 610, the method may include executing or trying to establish, at a wireless station, an application associated with a target application endpoint accessible via a wireless network. In some implementations, the wireless station may observe traffic from the application to determine the target application endpoint. Alternatively, the target application endpoint may be preconfigured or specified at a memory of the wireless station.

At 620, the method may include determining a first estimated throughput from the wireless station to the target application endpoint via a first access point of the wireless network. The first estimated throughput may be based, at least in part, upon a first wireless link rate associated with the first access point and a first application data rate from the first access point to the target application endpoint. In some embodiments, the first wireless link rate may be determined based upon a physical transmission rate, a wireless physical layer protocol, or based upon information obtained via service discovery process with the first access point. The first application data rate may be determined by receiving communications metrics regarding application data rates from the first access point to various application endpoints, the various application endpoints including at least the target application endpoint.

At 630, the method may include determining a second estimated throughput from the wireless station to the target application endpoint via a second access point of the wireless network. The second estimated throughput may be based, at least in part, upon a second wireless link rate associated with the second access point and a second application data rate from the second access point to the target application endpoint. In some embodiments, the second wireless link rate may be determined based upon a physical transmission rate, a wireless physical layer protocol, or based upon information obtained via service discovery process with the second access point. The second application data rate may be determined by receiving communications metrics regarding application data rates from the second access point to various application endpoints, the various application endpoints including at least the target application endpoint.

At 640, the method may include selecting one of the first access point or the second access point based, at least in part, upon the first estimated throughput and the second estimated throughput. At 650, the method may include associating with the selected one of the first access point or the second access point.

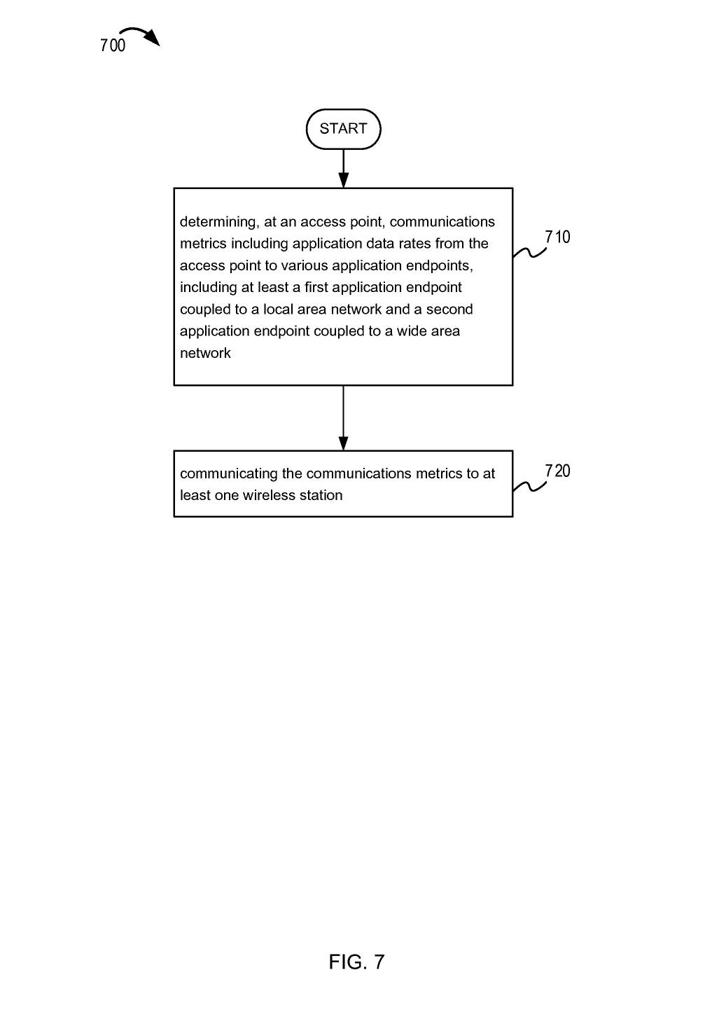

FIG. 7 depicts an example flow chart 700 for a method performed by an access point in accordance with an embodiment of this disclosure. The operations described in FIG. 7 are non-limiting examples, and various operations may be optionally omitted or added in particular implementations.

At 710, the method may include determining, at an access point, communications metrics including application data rates from the access point to various application endpoints, including at least a first application endpoint coupled to a local area network and a second application endpoint coupled to a wide area network. In some implementations, the access point may identify, as the various application endpoints, a plurality of local servers coupled to the local area network and at least one gateway device coupled to the wide area network.

At 720, the method may include communicating the communications metrics to at least one wireless station. In some implementations, the communications metrics may be included in a broadcast communication, such as a beacon packet.

It should be understood that FIGS. 1-7 and the operations described herein are examples meant to aid in understanding embodiments and should not be used to limit embodiments or limit scope of the claims. Embodiments may perform additional operations, fewer operations, operations in parallel or in a different order, and some operations differently.

As will be appreciated by one skilled in the art, aspects of the present inventive subject matter may be embodied as a system, method, or computer program product. Accordingly, aspects of the present inventive subject matter may take the form of an entirely hardware embodiment, a software embodiment (including firmware, resident software, micro-code, etc.) or an embodiment combining software and hardware aspects that may all generally be referred to herein as a “circuit,” “module” or “system.” Furthermore, aspects of the present inventive subject matter may take the form of a computer program product embodied in one or more computer readable medium(s) having computer readable program code embodied thereon.

Any combination of one or more non-transitory computer readable medium(s) may be utilized. Non-transitory computer-readable media comprise all computer-readable media, with the sole exception being a transitory, propagating signal. The non-transitory computer readable medium may be a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

Computer program code embodied on a computer readable medium for carrying out operations for aspects of the present inventive subject matter may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present inventive subject matter are described with reference to flowchart illustrations and/or block diagrams of methods, apparatus (systems) and computer program products according to embodiments of the inventive subject matter. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

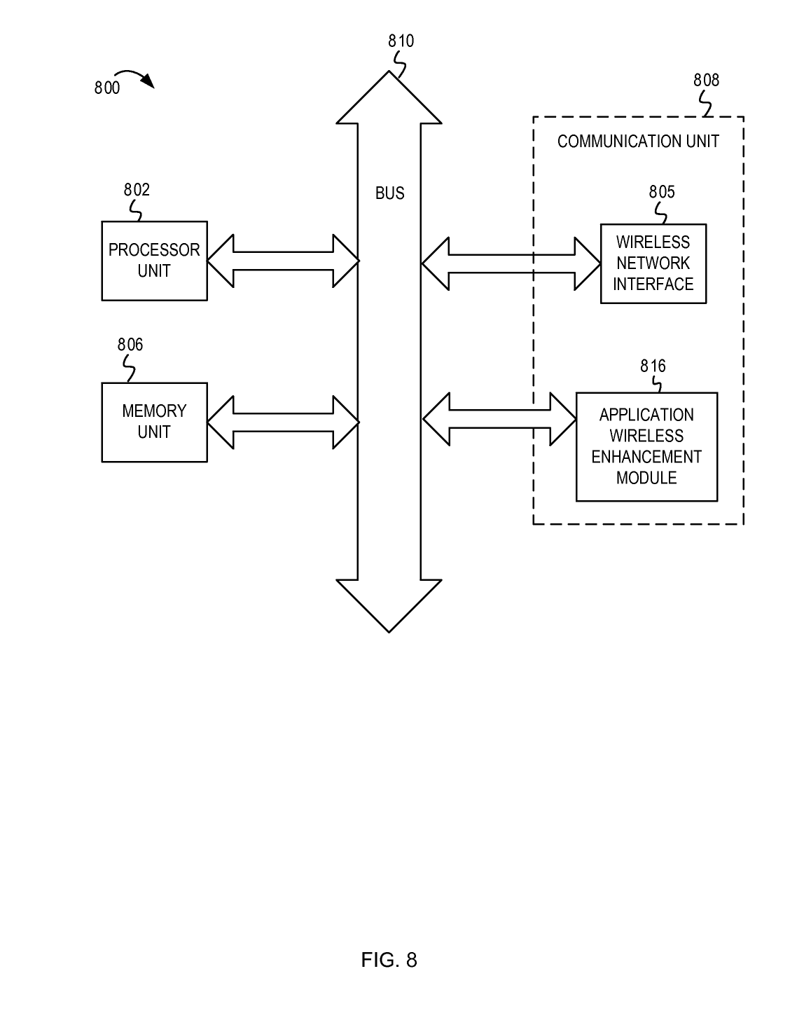

FIG. 8 is an example block diagram of one embodiment of an electronic device 800 (such as a wireless station or an access point) suitable for performing various embodiments of this disclosure. In some implementations, the electronic device 800 may be one of a laptop computer, a netbook, a mobile phone, a powerline communication device, a personal digital assistant (PDA), or other electronic systems. The electronic device 800 includes a processor unit 802 (possibly including multiple processors, multiple cores, multiple nodes, and/or implementing multi-threading, etc.). The electronic device 800 includes a memory unit 806. The memory unit 806 may be system memory (e.g., one or more of cache, SRAM, DRAM, zero capacitor RAM, Twin Transistor RAM, eDRAM, EDO RAM, DDR RAM, EEPROM, NRAM, RRAM, SONOS, PRAM, etc.) or any one or more of the above already described possible realizations of machine-readable media. The electronic device 800 also includes a bus 810 (e.g., PCI, ISA, PCI-Express, HyperTransport®, InfiniBand®, NuBus, AHB, AXI, etc.), and network interfaces 804, 805 that include at least one of a wireless network interface (e.g., a WLAN interface, a Bluetooth® interface, a WiMAX interface, a ZigBee® interface, a Wireless USB interface, etc.). In one example embodiment the wireless network interface 805 may comprise a 2.4 GHz or 5 GHz wireless interface capable of utilizing IEEE 802.11a, 802.11b, 802.11g, 802.11n, or 802.1 lac. In one example embodiment the wireless network interface 805 may comprise a 60 GHz wireless interface capable of utilizing IEEE 802.11ad.

The electronic device 800 also includes a wireless network interface 805 and an application wireless enhancement module 816. In some implementations, the wireless network interface 805 and the application wireless enhancement module 816 may be part of a communication unit 808. In some embodiments, the communication unit 808 may also have a dedicated processor (e.g., such as a communication unit comprising a system on a chip, or board with multiple chips, or multiple boards, in which the communication may have one or more dedicated processor or processing unit(s), in addition to the main processor 802). In some embodiments, the communication unit 808 may be implemented entirely or partially as software executed by an operating system of a computer system. For example, the communication unit 808 may be referred to as a driver (or drivers). Alternative, any one of these functionalities may be partially (or entirely) implemented in hardware and/or on the processor unit 802. For example, the functionality may be implemented with an application specific integrated circuit, in logic implemented in the processor unit 802, in a co-processor on a peripheral device or card, etc. Further, realizations may include fewer or additional components not illustrated in FIG. 8 (e.g., video cards, audio cards, additional network interfaces, peripheral devices, etc.). The processor unit 802, the memory unit 806, and the wireless network interfaces 805 are coupled to the bus 810. Although illustrated as being coupled to the bus 810, the memory unit 806 may be coupled to the processor unit 802. In other embodiments, the wireless network interface 805 and the application wireless enhancement module 816 may together be part of an integrated apparatus or chip for use in a computer system or device.

The application wireless enhancement module 816 may implement functionality associated with a wireless station and/or access point, as described above in FIGS. 1-7. For example, in one embodiment, the application wireless enhancement module 816 may implement functionality as described in either FIG. 6 (in an electronic device configured as a wireless station) or FIG. 7 (in an electronic device configured as an access point). It should be understood that the electronic device may include more than one wireless network interface and may be configured as a wireless station for one wireless network interface and may simultaneously be configured as an access point for another wireless network interface.

While the embodiments are described with reference to various implementations and exploitations, it will be understood that these embodiments are illustrative and that the scope of the inventive subject matter is not limited to them. In general, techniques for application aware association in wireless networks as described herein may be implemented with facilities consistent with any hardware system or hardware systems. Many variations, modifications, additions, and improvements are possible.

Plural instances may be provided for components, operations, or structures described herein as a single instance. Finally, boundaries between various components, operations, and data stores are somewhat arbitrary, and particular operations are illustrated in the context of specific illustrative configurations. Other allocations of functionality are envisioned and may fall within the scope of the inventive subject matter. In general, structures and functionality presented as separate components in the exemplary configurations may be implemented as a combined structure or component. Similarly, structures and functionality presented as a single component may be implemented as separate components. These and other variations, modifications, additions, and improvements may fall within the scope of the inventive subject matter.

What is claimed is:

1. A method comprising:
executing, at a wireless station, an application associated with a target application endpoint accessible via a wireless network;
determining a first estimated throughput from the wireless station to the target application endpoint via a first access point of the wireless network, wherein said first estimated throughput is based, at least in part, upon a first wireless link rate associated with the first access point and a first application data rate from the first access point to the target application endpoint;
determining a second estimated throughput from the wireless station to the target application endpoint via a second access point of the wireless network, wherein said second estimated throughput is based, at least in part, upon a second wireless link rate associated with the second access point and a second application data rate from the second access point to the target application endpoint;
selecting one of the first access point or the second access point based, at least in part, upon the first estimated throughput and the second estimated throughput; and
associating with the selected one of the first access point or the second access point.

2. The method of claim 1, further comprising:
receiving communications metrics regarding application data rates from the first access point to various application endpoints, the various application endpoints including at least the target application endpoint; and
receiving communications metrics regarding application data rates from the second access point to various application endpoints, the various application endpoints including at least the target application endpoint.

3. The method of claim 2, further comprising
receiving, from the first access point, a message that includes the first application data rate from the first access point to the target application endpoint as well as other application data rates from the first access point to other application endpoints.

4. The method of claim 2, further comprising:
receiving the communications metrics as broadcast messages from the first access point and the second access point.

5. The method of claim 4, wherein the broadcast messages comprise beacon packets.

6. The method of claim 1, further comprising:
receiving, from the first access point, first communications metrics including the first application data rate; and
receiving, from the second access point, second communications metrics including the second application data rate.

7. The method of claim 1, further comprising:
receiving, in a message from the first access point, the first application data rate and from the second access point the second application data rate.

8. The method of claim 1, wherein said determining the first estimated throughput includes estimating the first wireless link rate based upon a physical layer transmission rate.

9. The method of claim 1, wherein said determining the first estimated throughput includes estimating the first application data rate based upon upstream channel utilization for a connection at the first access point.

10. The method of claim 1, further comprising:
determining, at the wireless station, the target application endpoint associated with the application executing at the wireless station.

11. The method of claim 1, further comprising:
determining application requirements associated with multiple applications executing at the wireless station, the multiple applications associated with multiple application endpoints;
determining estimated throughputs associated with the application requirements via the first access point and the second access point; and
selecting one of the first access point or the second access point based upon the estimated throughputs.

12. A method for use in a wireless network having at least two access points, the method comprising:
determining, at a wireless station, a first local application throughput via a first access point to a target application endpoint in a local area network, and determining a first external application throughput via the first access point to a wide area network;
determining, at the wireless station, a second local application throughput via a second access point to the target application endpoint in the local area network, and determining a second external application throughput via the second access point to the wide area network;
determining that the wireless station is executing a first application associated with the target application endpoint in the local area network;
determining a higher one of the first local application throughput and the second local application throughput responsive to determining that the wireless station is executing the first application; and
associating with the first access point or the second access point based on the higher one of the first local application throughput and the second local application throughput.

13. The method of claim 12, further comprising:
determining that the wireless station is executing a second application associated with the wide area network;
determining a higher one of the first external application throughput and the second external application throughput responsive to determining that the wireless station is executing the second application; and
associating with the first access point or the second access point based on the higher one of the first external application throughput and the second external application throughput.

14. A method comprising:
determining, at an access point, communications metrics including application data rates from the access point to various application endpoints, including at least a first application endpoint coupled to a local area network and a second application endpoint coupled to a wide area network; and
communicating the communications metrics to at least one wireless station.

15. The method of claim 14, wherein said determining the communications metrics include:
identifying, as the various application endpoints, a plurality of local servers coupled to the local area network and at least one gateway device coupled to the wide area network.

16. The method of claim 14, wherein said communicating the communications metrics includes broadcasting the communications metrics in a beacon packet.

17. The method of claim 14, wherein said determining the communications metrics include:
determining a first application data rate to a first application server, as the first application endpoint, in the local area network; and
determining a second application data rate to a gateway device, as the second application endpoint, wherein the gateway device provides access to a wide area network.

18. A wireless station comprising:
a processor unit suitable to execute an application associated with a target application endpoint accessible via a wireless network;
an application wireless enhancement module suitable to:
determine a first estimated throughput from the wireless station to the target application endpoint via a first access point of the wireless network, wherein said first estimated throughput is based, at least in part, upon a first wireless link rate associated with the first access point and a first application data rate from the first access point to the target application endpoint;
determine a second estimated throughput from the wireless station to the target application endpoint via a second access point of the wireless network, wherein said second estimated throughput is based, at least in part, upon a second wireless link rate associated with the second access point and a second application data rate from the second access point to the target application endpoint; and
select one of the first access point or the second access point based, at least in part, upon the first estimated throughput and the second estimated throughput; and
a wireless network interface suitable to associate with the selected one of the first access point or the second access point.

19. The wireless station of claim 18, wherein the wireless network interface configured to:
receive communications metrics regarding application data rates from the first access point to various application endpoints, the various application endpoints including at least the target application endpoint; and
receive communications metrics regarding application data rates from the second access point to various application endpoints, the various application endpoints including at least the target application endpoint.

20. The wireless station of claim 19, wherein the wireless network interface configured to receive the communications metrics as broadcast messages from the first access point and the second access point.

21. The wireless station of claim 19, wherein the application wireless enhancement module is suitable to determine the first estimated throughput by estimating the first wireless link rate based upon a physical layer transmission rate.

22. The wireless station of claim 19, wherein the application wireless enhancement module is suitable to determine the first estimated throughput by estimating the first application data rate based upon upstream channel utilization for an upstream connection at the first access point.

23. An access point comprising:
an application wireless enhancement module suitable to determine communications metrics including application data rates from the access point to various application endpoints, including at least a first application endpoint coupled to a local area network and a second application endpoint coupled to a wide area network; and
a wireless network interface suitable to communicate the communications metrics to at least one wireless station.

24. The access point of claim 23, wherein the application wireless enhancement module is further suitable to identify, as the various application endpoints, a plurality of local servers coupled to the local area network and at least one gateway device coupled to the wide area network.

25. The access point of claim 23, wherein the wireless network interface is suitable to communicate the communications metrics by broadcasting the communications metrics in a beacon packet.

26. The access point of claim 23, wherein the application wireless enhancement module is further suitable to:
determine a first application data rate to a first application server, as the first application endpoint, in the local area network; and
determine a second application data rate to a gateway device, as the second application endpoint, wherein the gateway device provides access to a wide area network.
